(19) United States
(12) Patent Application Publication
(10) Pub. No.: US 2026/0140798 A1
(43) Pub. Date: May 21, 2026

(54) APPLICATION RATE LIMIT

(71) Applicant: SAP SE, Walldorf (DE)

(72) Inventor: Dennis Ahaus, Bad Essen (DE)

(21) Appl. No.: 18/950,867

(22) Filed: Nov. 18, 2024

(51) Int. Cl. G06F 9/54; G06F 9/50

(52) U.S. Cl. CPC G06F 9/547; G06F 9/5038

(57) ABSTRACT

An application rate limit limits the number of requests a tenant can make to an application in a period of time. A dynamic rate limit for an application may be determined based on request priority, tenants using the application, an amount of resources available to the application, or any suitable combination thereof. A tenant may be informed of the current dynamic rate limit in responses to requests sent to the application. Promotions may be generated by a cloud service provider to take advantage of the dynamic rate limits. When the cloud service provider determines that a higher rate of requests from the tenant could be efficiently handled, a promotion may be generated that offers to service additional requests at a reduced incremental cost.

### TECHNICAL FIELD

The subject matter disclosed herein generally relates to rate limits for application programming interface (API) calls and, more specifically, to dynamic rate limits for API calls.

### BACKGROUND

Underlying resources or processes for APIs are protected by setting a rate limit for each consumer, such as 100 requests/second. The resources may be sufficient to respond to all calls for multiple consumers at the defined rate limit.

### BRIEF DESCRIPTION OF THE DRAWINGS

FIG. 1 shows a network diagram illustrating an example network environment suitable for implementing an application rate limit for tenants.

FIG. 2 shows a block diagram of an application server, suitable for implementing an application rate limit for tenants.

FIG. 3 shows an illustration of an example neural network, suitable for use in determining application rate limits for tenants, generating promotions related to application rate limits for tenants, or any suitable combination thereof.

FIGS. 4A-4C show an example class library for use in providing application rate limits for tenants.

FIGS. 5A-5C show a swim lane diagram illustrating communications to implement application rate limits for tenants, according to some example embodiments.

FIG. 6 shows a flowchart illustrating a method of generating and applying application rate limits for tenants, according to some example embodiments.

FIG. 7 shows a flowchart illustrating a method of generating promotions for applications, according to some example embodiments.

FIG. 8 shows a block diagram showing one example of a software architecture for a computing device.

FIG. 9 shows a block diagram of a machine in the example form of a computer system within which instructions may be executed for causing the machine to perform any one or more of the methodologies discussed herein.

### DETAILED DESCRIPTION

Example methods and systems are directed to application rate limits for cloud applications. An application rate limit limits the number of requests a tenant can make to an API in a period of time (e.g., 100 requests/second, 10,000 requests/hour, or the like). When a tenant reaches the rate limit, further requests by the tenant are rejected. The purpose of the rate limit is to protect the resources used by the API to ensure that the resources are not consumed by one tenant, negatively affecting other tenants. However, existing rate limits are not dynamic. As a result, when additional resources become available, they may be under-utilized.

Additionally, traditional rate limits simply limit the number of requests that may be made by a tenant to an API, without differentiating between the types of requests. For example, an HTTP POST request to an API may be more important than an HTTP GET request. Accordingly, an adjustment to the tenant's rate limit may be applied to allow the tenant to successfully complete an HTTP POST request while an HTTP GET request would be denied.

As discussed herein, dynamic rate limits are generated and applied. A dynamic rate limit for an application may be determined based on request priority, tenants using the application, an amount of resources available to the application, or any suitable combination thereof. A tenant may be informed of the current dynamic rate limit in responses to requests sent to the application. For example, a response to a request may indicate whether the request was accepted or denied, a number of remaining requests that will be accepted within a predetermined period of time (e.g., the next minute or the next hour), a cost associated with additional requests (e.g., measured in dollars per 100 requests), or any suitable combination thereof.

By way of example, the application rate limit is discussed as being a per-tenant rate limit. In various embodiments, the application rate limit is applied on a per-user basis, a per-internet protocol (IP) address basis, or any suitable combination thereof.

Applying dynamic rate limits allows for better allocation of resources within a cloud environment. For example, two APIs may share an underlying resource. To ensure that the resource is not over-taxed, usage of the resource is allocated to the two APIs, and usage of the APIs is allocated to tenants. However, if usage of one API is negatively correlated with usage of the other API during certain periods of times, the rate limit for the API having increased demand may be increased and the rate limit for the API having decreased demand may be decreased. As a result, instead of the resource being under-utilized, more requests may be processed.

Promotions may be generated by a cloud service provider to take advantage of the dynamic rate limits. For example, a tenant may have a subscription to an application that guarantees the tenant a certain rate limit for a fixed price. When the cloud service provider determines that a higher rate of requests from the tenant could be efficiently handled, a promotion may be generated that offers to service additional requests at a reduced incremental cost. Alternatively, when the cloud service provider determines that a lower rate of requests from the tenant during a period of time would be advantageous, a promotion may be generated that offers a rebate to the tenant for reducing the request rate during the period of time.

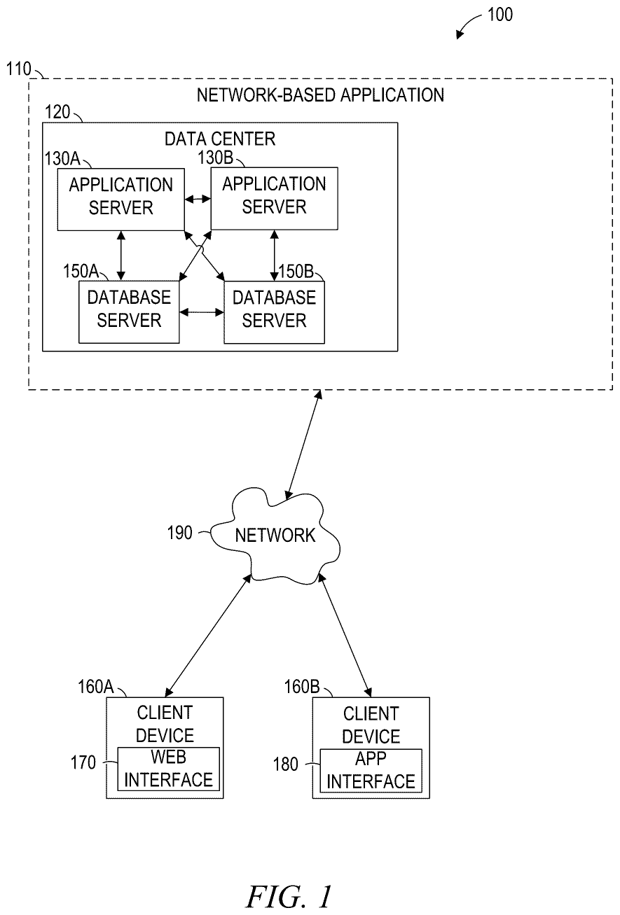

FIG. 1 shows a network diagram illustrating an example network environment 100 suitable for implementing an application rate limit for tenants. The network environment 100 includes a network-based application 110, client devices 160A and 160B, and a network 190. The network-based application 110 is implemented at a data center 120 comprising application servers 130A and 130B in communication with database servers 150A and 150B. An application executing on the application servers 130A-130B may access data from the database servers 150A-150B. The letter suffixes of reference numbers may be omitted when doing so does not raise ambiguity. For example, the application servers 130A-130B may be referred to collectively as “application servers 130.” Similarly, when the specific one of the application servers 130A-130B is not of particular import, “application server 130” may be referenced.

The application running on the application server 130 may provide services to the client devices 160A and 160B. For example, a user of the client device 160A may be an employee of a business using a business application. The user may use the services to generate invoices, manage employees, develop other applications, or any suitable combination thereof. Use of the application may entail filtering data (e.g., to review certain invoices, employees, applications, or the like). The user interface (UI) for the application may be presented using a web interface 170 or an app interface 180.

The application 110 may be implemented using a collection of microservices. One or more of the application servers 130 may act as a registration server. Microservices register themselves with the registration server. Once a microservice is registered, it can be discovered by requests to the registration server. For example, a user of the client device 160A may request information about a microservice by providing the name of the microservice or a description of the microservice to the registration server. In response, the registration server provides information about one or more registered microservices. The user may use the provided information to configure the network-based application 110 to make use of one or more of the microservices.

Each tenant may have a call rate limit for each service (e.g., 100 calls/second allowed from Tenant A to Service A, 150 calls/second allowed from Tenant A to Service B, 50 calls/second allowed from Tenant B to Service A, and so on). Alternatively, each tenant may have a total call rate limit for services in the aggregate (e.g., 200 calls/second allowed from Tenant A to services, 100 calls/second allowed from Tenant B to services, and so on). As disclosed herein, the call rate limit may vary over time based on tenant priority, resource availability, or both.

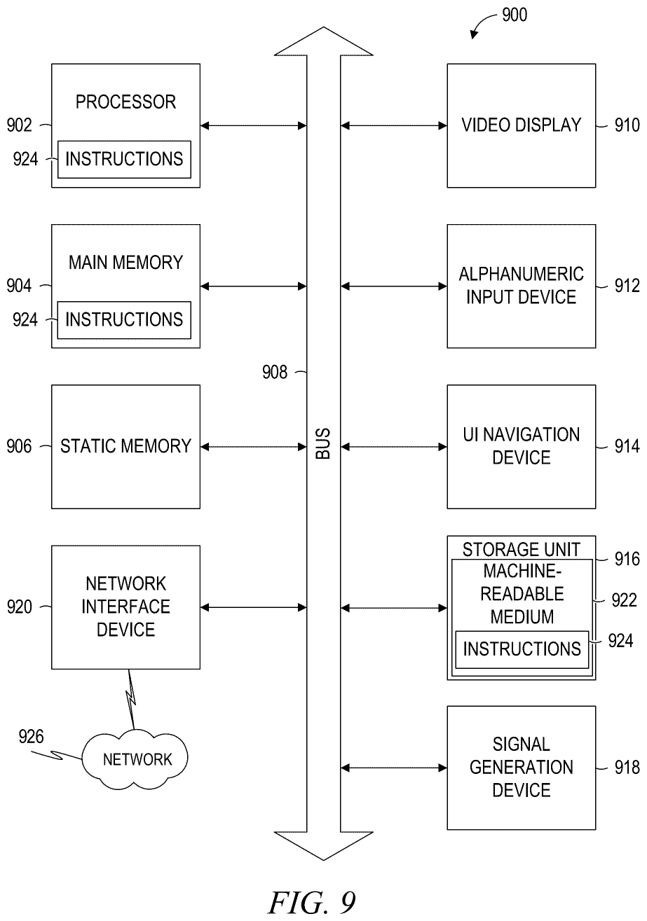

The application servers 130 may communicate with the database servers 150 using a REST API, OData, or another API. The application servers 130A-130B, the database servers 150A-150B, and the client devices 160A-160B may each be implemented in a computer system, in whole or in part, as described below with respect to FIG. 9. Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 9.

As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database, a disk-based database, a remote database, or any suitable combination thereof. Moreover, any two or more of the machines, databases, or devices illustrated in FIG. 1 may be combined into a single machine, database, or device, and the functions described herein for any single machine, database, or device may be subdivided among multiple machines, databases, or devices.

The application servers 130A-130B, the database servers 150A-150B, and the client devices 160A-160B are connected by the network 190. The network 190 may be any network that enables communication between or among machines, databases, and devices. Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

Though FIG. 1 shows only one or two of each element (e.g., one data center 120, two application servers 130A-130B, two client devices 160A and 160B, and the like), any number of each element is contemplated. For example, the application server 130A may be one of dozens or hundreds of active and standby servers and provide services to millions of client devices.

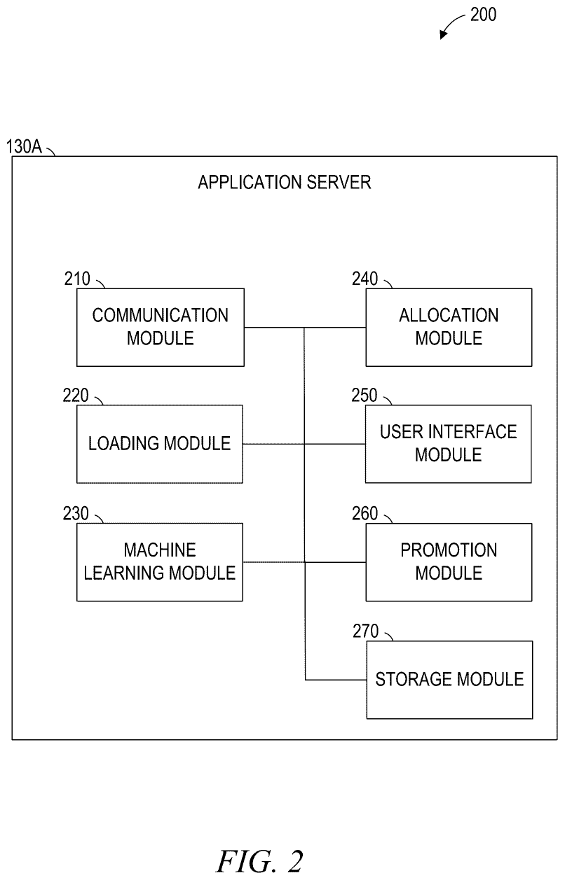

FIG. 2 shows a block diagram 200 of the application server 130A, suitable for implementing an application rate limit for tenants. The application server 130A is shown as including a communication module 210, a loading module 220, a machine learning module 230, an allocation module 240, a user interface module 250, a promotion module 260, and a storage module 270, all configured to communicate with each other (e.g., via a bus, shared memory, or a switch). Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, modules described herein as being implemented within a single machine, database, or device may be distributed across multiple machines, databases, or devices.

The communication module 210 receives data sent to the application server 130A and transmits data from the application server 130A. The communication module 210 may access data from the database servers 150, such as metadata of multiple tenants, logs for multiple services, historical loading data, or any suitable combination thereof. The accessed data may be provided to the loading module 220 to determine the loads of various services, to the machine learning module 230 for training or analysis, to the promotion module 260 for use in generating promotions, or any suitable combination thereof.

The loading module 220 determines the loading of one or more services. The allocation module 240 may use the determined loading to adjust application rate limits for the one or more services. The machine learning module may be trained on historical usage data to predict future usage data. The allocation module 240 may use the predicted usage data to adjust application rate limits for the one or more services.

The promotion module 260 may use the predicted usage data to generate one or more promotions. The user interface module 250 may cause the generated promotions to be presented on a user interface (e.g., by generating a web page that is sent by the communication module 210 via the network 190 for display by the web interface 170 of the client device 160A, all of FIG. 1. User input may be received via the user interface to adjust the proposed promotion.

The adjusted promotion may be presented to a tenant via a second user interface. Based on the tenant accepting the promotion, the allocation module 240 adjusts one or more application rate limits for the tenant.

Data, metadata, documents, instructions, or any suitable combination thereof may be stored and accessed by the storage module 270. For example, local storage of the application server 130A, such as a hard drive, may be used. As another example, network storage may be accessed by the storage module 270 via the network 190.

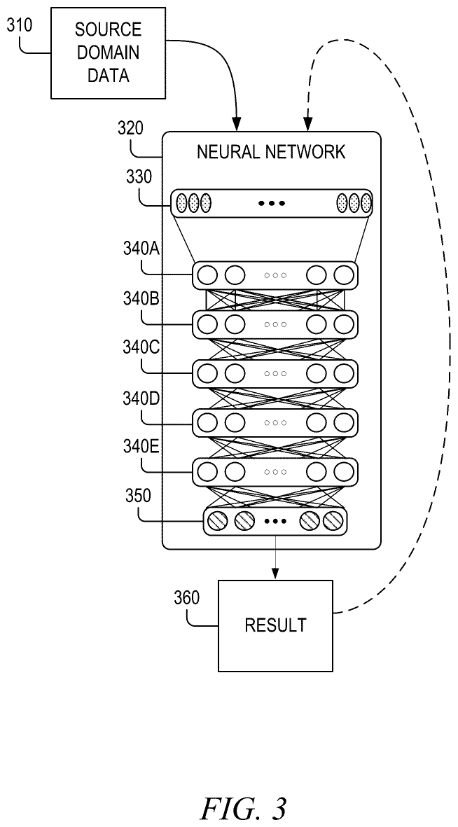

FIG. 3 shows an illustration of an example neural network 320, suitable for use in determining application rate limits for tenants, generating promotions related to application rate limits for tenants, or any suitable combination thereof. The neural network 320 takes source domain data 310 as input and processes the source domain data 310 using an input layer 330; intermediate, hidden layers 340A, 340B, 340C, 340D, and 340E; and output layer 350 to generate a result 360.

A neural network, sometimes referred to as an artificial neural network, is a computing system based on consideration of biological neural networks of animal brains. Such systems progressively improve performance, which is referred to as learning, to perform tasks, typically without task-specific programming. For example, in image recognition, a neural network may be taught to identify images that contain an object by analyzing example images that have been tagged with a name for the object and, having learned the object and name, may use the analytic results to identify the object in untagged images.

A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

Each of the layers 330-350 comprises one or more nodes (or “neurons”). The nodes of the neural network 320 are shown as circles or ovals in FIG. 3. Each node takes one or more input values, processes the input values using zero or more internal variables, and generates one or more output values. The inputs to the input layer 330 are values from the source domain data 310. The output of the output layer 350 is the result 360. The intermediate layers 340A-340E are referred to as “hidden” because they do not interact directly with either the input or the output and are completely internal to the neural network 320. Though five hidden layers are shown in FIG. 3, more or fewer hidden layers may be used.

A model may be run against a training dataset for several epochs, in which the training dataset is repeatedly fed into the model to refine its results. In each epoch, the entire training dataset is used to train the model. Multiple epochs (e.g., iterations over the entire training dataset) may be used to train the model. In some example embodiments, the number of epochs is 10, 100, 500, or 1000. Within an epoch, one or more batches of the training dataset are used to train the model. Thus, the batch size ranges between one and the size of the training dataset, and the number of epochs is any positive integer value. The model parameters are updated after each batch (e.g., using gradient descent).

For self-supervised learning, the training dataset comprises self-labeled input examples. For example, a set of color images could be automatically converted to black-and-white images. Each color image may be used as a “label” for the corresponding black-and-white image and used to train a model that colorizes black-and-white images. This process is self-supervised because no additional information, outside of the original images, is used to generate the training dataset. Similarly, when text is provided by a user, one word in a sentence can be masked and the network trained to predict the masked word based on the remaining words.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the nth epoch, the learning phase may end early and use the produced model, satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs—having reached a performance plateau—the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusters is used to select a model that produces the clearest bounds for its clusters of data.

The neural network 320 may be a deep learning neural network, a deep convolutional neural network (CNN), a recurrent neural network, a transformer neural network, or another type of neural network. A neuron is an architectural element used in data processing and artificial intelligence, particularly machine learning. A neuron implements a transfer function by which a number of inputs are used to generate an output. In some example embodiments, the inputs are weighted and summed, with the result compared to a threshold to determine if the neuron should generate an output signal (e.g., a 1) or not (e.g., a 0 output). The inputs of the component neurons are modified through the training of a neural network. One of skill in the art will appreciate that neurons and neural networks may be constructed programmatically (e.g., via software instructions) or via specialized hardware linking each neuron to form the neural network.

An example type of layer in the neural network 320 is a Long Short Term Memory (LSTM) layer. An LSTM layer includes several gates to handle input vectors (e.g., time-series data), a memory cell, and an output vector. The input gate and output gate control the information flowing into and out of the memory cell, respectively, whereas forget gates optionally remove information from the memory cell based on the inputs from linked cells earlier in the neural network. Weights and bias vectors for the various gates are adjusted over the course of a training phase, and once the training phase is complete, those weights and biases are finalized for normal operation.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input. Thus, the coefficients assign significance to inputs for the task the algorithm is trying to learn. These input-weight products are summed, and the sum is passed through what is called a node's activation function, to determine whether and to what extent that signal progresses further through the network to affect the ultimate outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a pre-determined range, based on the known training images, backpropagation is used, where backpropagation is a common method of training artificial neural networks that are used with an optimization method such as a stochastic gradient descent (SGD) method.

Use of backpropagation can include propagation and weight updates. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value, which roughly represents its contribution to the original output. Backpropagation can use these error values to calculate the gradient of the cost function with respect to the weights in the neural network. The calculated gradient is fed to the selected optimization method to update the weights to attempt to minimize the cost function.

In some example embodiments, the structure of each layer is predefined. For example, a convolution layer may contain small convolution kernels and their respective convolution parameters, and a summation layer may calculate the sum, or the weighted sum, of two or more values. Training assists in defining the weight coefficients for the summation.

One way to improve the performance of DNNs is to identify newer structures for the feature-extraction layers, and another way is by improving the way the parameters are identified at the different layers for accomplishing a desired task. For a given neural network, there may be millions of parameters to be optimized. Trying to optimize all these parameters from scratch may take hours, days, or even weeks, depending on the amount of computing resources available and the amount of data in the training set.

One of ordinary skill in the art will be familiar with several machine learning algorithms that may be applied with the present disclosure, including linear regression, random forests, decision tree learning, neural networks, DNNs, genetic or evolutionary algorithms, and the like. With the help of natural language processing (NLP) and advanced data pre-processing, a machine learning model (e.g., the neural network 320) can be trained on historical (existing) data (for instance, resource usage data) from the system to predict future data.

The transformer architecture processes an entire input at once rather than sequentially. For example, a recurrent neural network (RNN) processes words or sentences sequentially, with the output of the RNN treated as an input for each input after the first (thus the use of the word “recurrent” in the name). As a result, relationships between elements that are far apart in the input are difficult to detect. The transformer architecture receives a larger input and learns the interrelationships between the elements and the output using an attention mechanism. Since all elements are processed together, distance between the elements of the input does not affect the learning process. The output may still be generated sequentially, with the previous result (e.g., word for an LLM, pixel for an image-generating artificial intelligence, and the like) being provided as an input for determination of the next result.

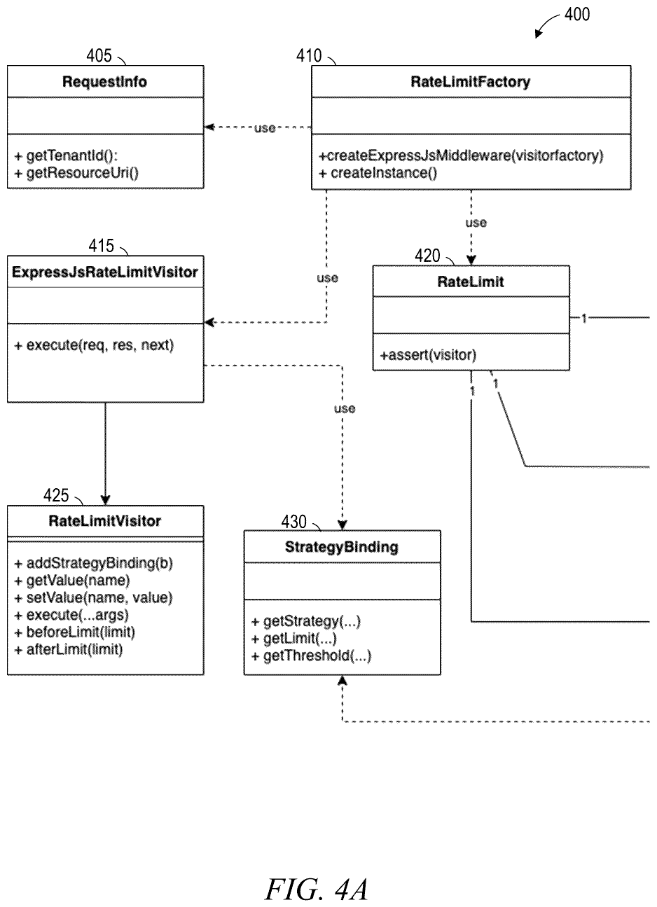

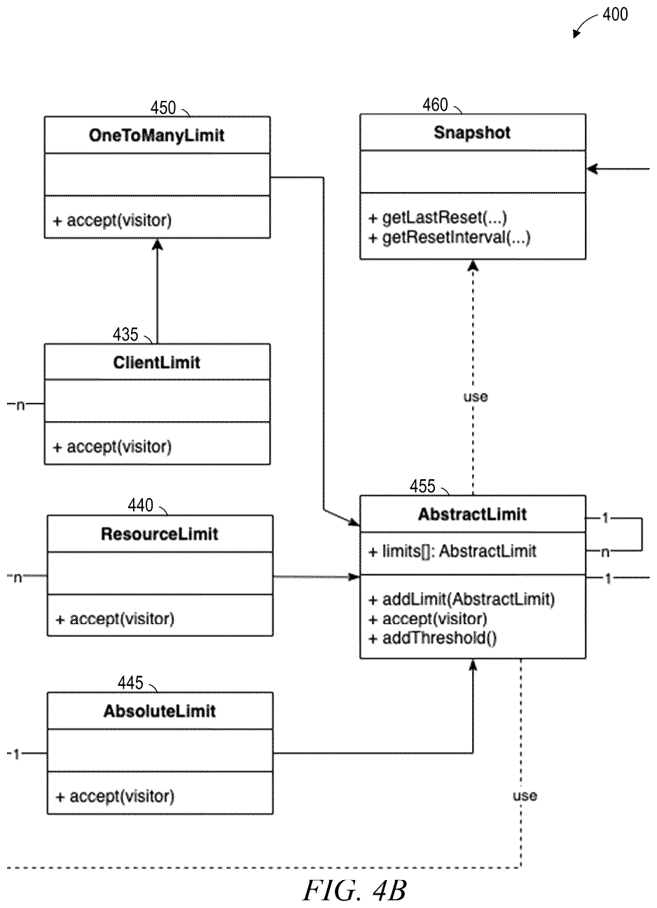

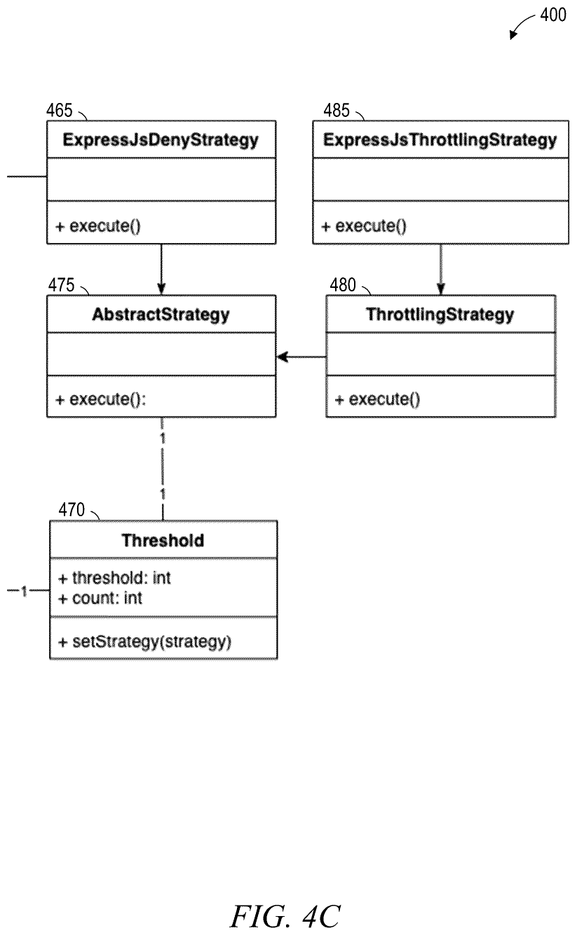

FIGS. 4A-4C show an example class library 400 for use in providing application rate limits for tenants. FIG. 4A shows classes 405, 410, 415, 420, 425, and 430. FIG. 4B shows classes 435, 440, 445, 450, 455, and 460. FIG. 4C shows classes 465, 470, 475, 480, and 485. Each of the classes 405-485 is shown with a name, one or more methods of the class, and one or more relationships with other classes.

The example class library 400 is for use in an Express.js framework. The Express.js framework provides functionality for web applications that handle HTTP requests, and is built on top of the Node.js Javascript runtime environment. The classes with names beginning with ExpressJs are adapters that coordinate between a concrete implementation of functionality and the Express.js framework.

The RateLimitFactory class 410 is responsible for creating and managing instances of the RateLimit class 420. The RateLimitFactory class 410 has methods to get tenant ID and resource URI. The RateLimit class 420 is the central class of the system, which uses RateLimitVisitor and contains an array of AbstractLimit objects.

The AbstractLimit class 455 is an abstract base class for different types of limits. The AbstractLimit class 455 has methods to add limits and thresholds. The concrete limit classes include the OneToManyLimit class 450, the ClientLimit class 435, the ResourceLimit class 440, and the AbsoluteLimit class 445. The classes 435-450 all inherit from the AbstractLimit class 455 and implement an accept (visitor) method.

The RateLimitVisitor class 425 defines methods for visiting different parts of the rate limit system, including strategy bindings and limit operations. The ExpressJsRateLimitVisitor class 415 adapts the RateLimit Visitor class 425 for Express.js middleware.

The StrategyBinding class 430 associates strategies with limits and thresholds. The AbstractStrategy class 475 is a base class for different rate limiting strategies. The concrete strategy classes include the ThrottlingStrategy class 480 and the ExpressJsThrottlingStrategy class 485. The ExpressJsDenyStrategy class 465 inherits from the AbstractStrategy class 475 and implements an execute( ) method. Additionally, the ExpressJsDenyStrategy class 465 adapts the AbstractStrategy class 475 for Express.js middleware.

The ThrottlingStrategy class 480 inherits from the AbstractStrategy class 475 and implements an execute( ) method. The ExpressJsThrottlingStrategy class 485 inherits from the ThrottlingStrategy class 480, and adapts the ThrottlingStrategy class 480 for Express.js middleware.

The Threshold class 470 represents a threshold with a count. The Snapshot class 460 manages reset intervals and last reset times for rate limiting.

The example class library 400 allows for a flexible and extensible rate limiting system that can be applied to different scenarios, such as client-based or resource-based rate limiting, with various strategies for handling limit violations.

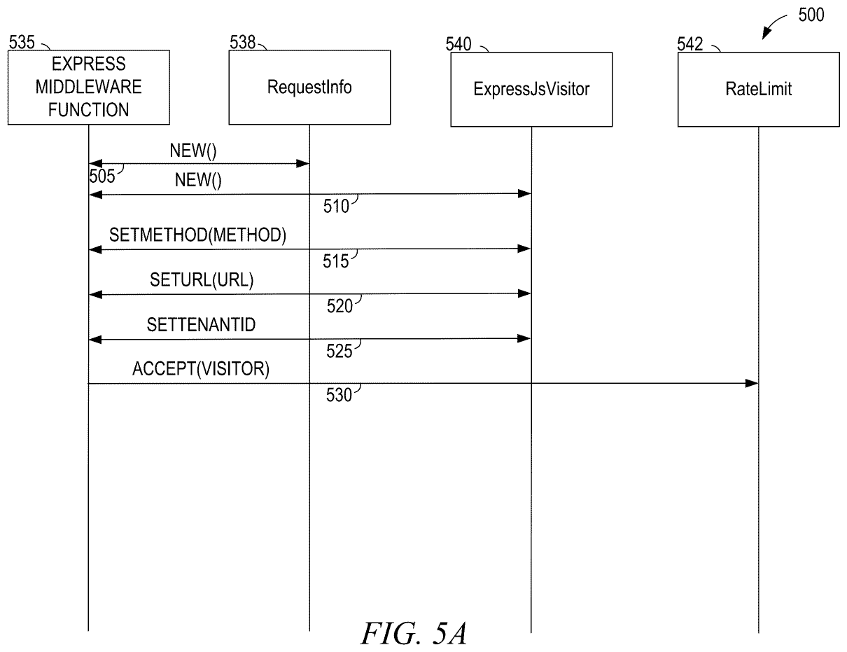

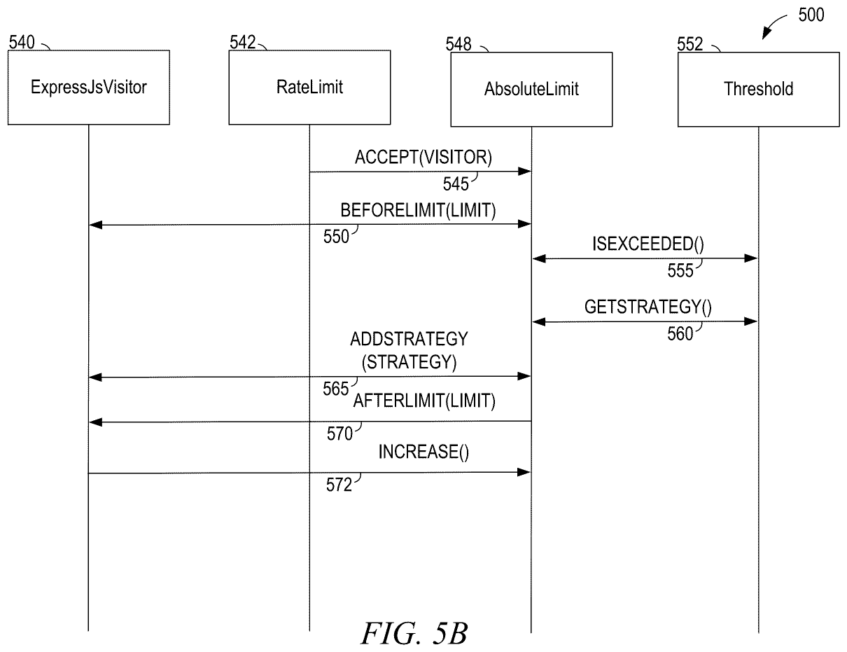

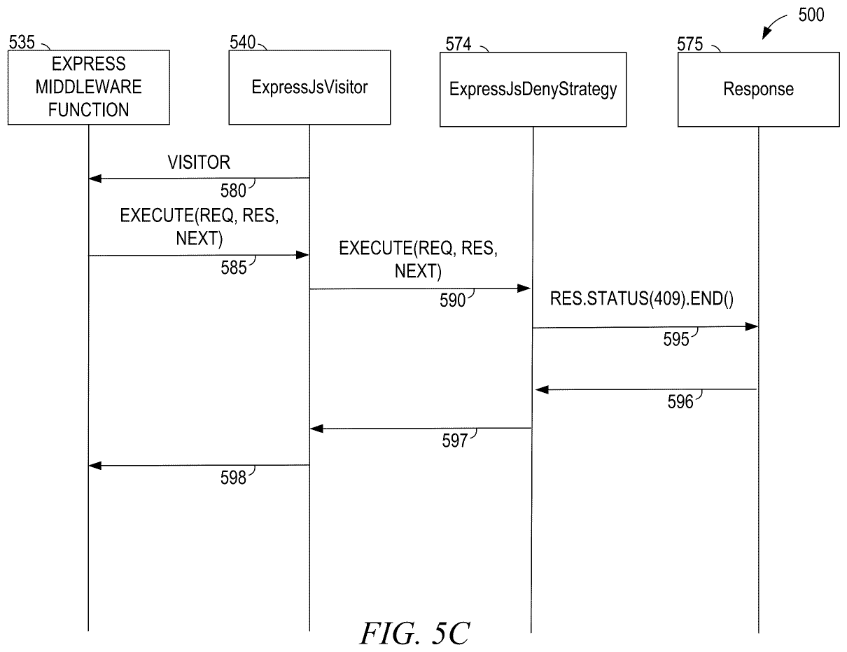

FIGS. 5A-5C show a swim lane diagram 500 illustrating communications to implement application rate limits for tenants, according to some example embodiments. The instances of classes may be referred to as objects. For example, “RequestInfo object 538” refers to an instance of the RequestInfo object 538 shown in FIGS. 5A-5C.

FIG. 5A shows communications 505, 510, 515, 520, 525, and 530 among an express middleware function 535, a RequestInfo object 538, an ExpressJsVisitor 540, and a RateLimit object 542. FIG. 5B shows communications 545, 550, 555, 560, 565, 570, and 572 among the ExpressJs Visitor 540, the RateLimit object 542, an AbsoluteLimit object 548, and a Threshold object 552. FIG. 5C shows communications 580, 585, 590, 595, 596, 597, and 598 among the express middleware function 535, the ExpressJs Visitor 540, an ExpressJsDenyStrategy object 574, and a Response 575.

Communications within a single one of the FIGS. 5A-5C occur sequentially from top to bottom, in some example embodiments. Communications of FIG. 5A occur before communications of FIG. 5B and communications of FIG. 5B occur before communications of FIG. 5C, in some example embodiments. The communications shown with double arrows indicate a request and a response between the two entities. The communications shown with single arrows indicate a request or response individually.

The sequence begins with the express middleware function 535, which is the entry point for handling HTTP requests in an Express.js application. The express middleware function 535 creates the RequestInfo object 538 using communication 505. The RequestInfo object 538 contains information about the incoming HTTP request. The express middleware function 535 creates the ExpressJsVisitor 540 using communication 510. The ExpressJsVisitor 540 is an instance of the visitor pattern, specifically designed for Express.js.

The express middleware function 535 configures the ExpressJs Visitor 540 using the communications 515, 520, and 525. The setMethod (method) call sets the HTTP method of the request, the setUrl(url) call sets the URL of the request, and the setTenantId call sets the tenant ID, to distinguish between tenants.

The express middleware function 535 initiates the rate limit configuration in communication 530 to the RateLimit object 542, an accept (visitor) call. The RateLimit object 542 calls accept (visitor) on the AbsoluteLimit object 548, initiating the visitor pattern in communication 545.

The AbsoluteLimit object 548 performs several steps. First, the AbsoluteLimit object 548 calls beforeLimit(limit) on the visitor (communication 550). Then, the AbsoluteLimit object 548 checks to see if a threshold is exceeded (communication 555). The isExceeded( ) call, in this example, returns true. Accordingly, the AbsoluteLimit object 548 requests a strategy to address the exceeding of the threshold, in communication 560. The Threshold object 552 responds to the getStrategy( ) call with a strategy object. In this example, the strategy object is the ExpressJsDenyStrategy object 574.

In communication 565, the AbsoluteLimit object 548 adds a strategy using addStrategy(strategy). The AbsoluteLimit object 548 calls, in communication 570, afterLimit(limit) on the visitor. Then, the AbsoluteLimit object 548 increases an internal counter corresponding to a rate limit (communication 572).

The ExpressJsVisitor 540 sends the visitor object to the express middleware function 535 in communication 580. The express middleware function 535 executes the request by invoking the execute (req, res, next) call in communication 585. In communication 590, the execute (req, res, next) call is delegated by the ExpressJsVisitor 540 to the ExpressJsDenyStrategy object 574. If the rate limit is exceeded, the ExpressJsDenyStrategy object 574 sets a 409 status code (Conflict) and ends the response. The Response 575 is returned to the express middleware function 535 via communications 596, 597, and 598.

The swim lane diagram 500 illustrates the flow of a typical rate limiting process in an Express.js middleware, showing how different components interact to enforce rate limits on incoming requests.

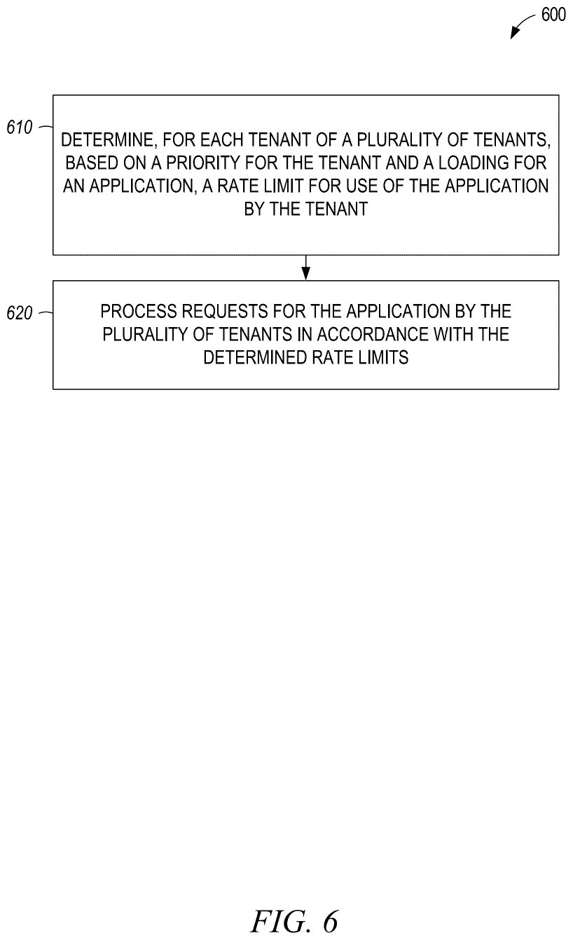

FIG. 6 shows a flowchart illustrating a method 600 of generating and applying application rate limits for tenants, according to some example embodiments. The method 600 includes operations 610 and 620. By way of example and not limitation, the method 600 is described as being performed by the application server 130A of FIG. 1, using the modules of FIG. 2.

In operation 610, the allocation module 240 determines, for each tenant of a plurality of tenants, based on a priority for the tenant and a loading for an application, a rate limit for use of the application by the tenant. For example, high priority tenants may have a minimum rate limit of 100 requests/second, medium priority tenants may have a minimum rate limit of 50 requests/second, and low priority tenants may have a minimum rate limit of 10 requests/second. When the loading of the application is such that additional requests beyond the minimums can be successfully processed by the application, the rate limit for each tenant may be increased by an equal percentage so that the available processing of the application is fully allocated to the tenants.

Continuing with this example, suppose that there are two high priority tenants, one medium priority tenant, and one low priority tenant. The total minimum rate limit for the four tenants is 260 requests/second. If the allocation module 240 determines that, based on the loading for the application and the available resources for the application, the application can process 500 requests/second, the rate limit for each tenant is increased by the factor of

$$\frac{Available Rate}{Minimum Rate} .$$

In this case, the available rate is 500 and the minimum rate is 260, so each tenant's rate limit is increased by a factor of 1.923. Accordingly, the high priority tenants' rate limits are determined to be 192 requests/second, the medium priority tenant's rate limit is determined to be 96 requests/second, and the low priority tenant's rate limit is determined to be 19 requests/second.

The application server 130A, in operation 620, processes requests for the application by the plurality of tenants in accordance with the determined rate limits. Thus, requests by a tenant in excess of their minimum rates but below the rates determined in operation 610 will be serviced. Requests in excess of the rates determined in operation 610 will be rejected or queued for later processing.

The method 600 may be performed on a live system that is actively processing application requests. Accordingly, the rate limit for a tenant may be modified while processing requests by the tenant. For example, at 9 AM, the tenant may have been allocated its minimum rate (e.g., 100 requests/second). At 10 AM, operation 610 may be executed and the tenant's rate limit updated to 192 requests/second. Accordingly, the 101^{st}-192^{nd} requests in a second will not be rejected after 10 AM. However, if the tenant is not aware of the increased rate limit, the tenant cannot take advantage of it.

The tenant may be informed of the changed rate limit in a variety of ways. In some example embodiments, the service provider sends an independent message to the tenant that indicates the application and the determined rate limit. In other example embodiments, the service provider responds to a request by the tenant for the application with a response that indicates a current rate limit.

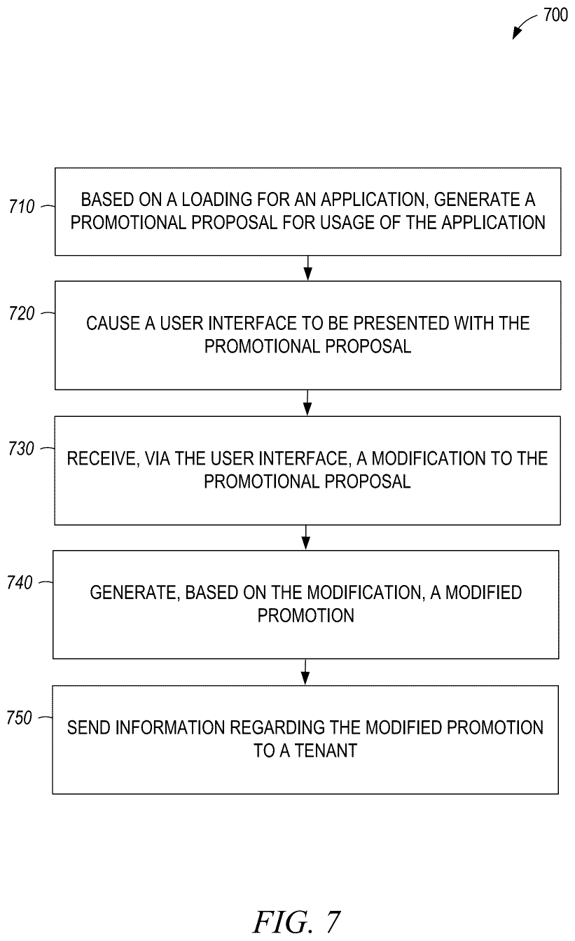

FIG. 7 shows a flowchart illustrating a method 700 of generating promotions for applications, according to some example embodiments. The method 700 includes operations 710, 720, 730, 740, and 750. By way of example and not limitation, the method 700 is described as being performed by the application server 130A of FIG. 1, using the modules of FIG. 2.

In operation 710, the promotion module 260 generates, based on a loading for an application, a promotional proposal for usage of the application. For example, as discussed above with respect to FIG. 6, an application may be used by tenants that, in total, are entitled to a minimum of 260 requests/per second but, based on loading for the application and available resources for the application, the loading module 220 determines that the application could service 500 requests/per second, a difference of 240 requests/second.

Using this information, the promotion module 260 determines to propose a promotion for usage of the application. For example, the promotion may offer a 92% increase in the rate limit in exchange for a 40% increase in usage fees. In this example, the tenants are offered a substantial discount for the additional usage, but the service provider gains because the resources for the application would otherwise have gone idle.

The promotional proposal generated in operation 710 may be based on a determination that the loading for the application will be below a predetermined threshold during a future period of time. The generated proposal may include offering, to a first tenant, a discount for usage of the application during the future period of time. For example, if the loading for the application is below a predetermined threshold of 70% during the next hour, a high priority tenant may be selected to be offered a discount for use of the application during the next hour. The amount of the discount may be based on the loading for the application and the predetermined threshold. For example, the discount may be based on the difference between the loading and the threshold, such that a greater difference results in a greater discount.

The promotional proposal generated in operation 710 may be based on a determination that the loading for the application will be above a predetermined threshold during a future period of time. The generated proposal may include, offering, to a first tenant, a rebate for reduced usage of the application during the future period of time. For example, if the loading for the application is above a predetermined threshold of 95% during the next hour, a high usage tenant may be selected to be offered a rebate for reduced usage of the application during the next hour. The amount of the discount may be based on the loading for the application and the predetermined threshold. For example, the discount may be based on the difference between the loading and the threshold, such that a greater difference results in a greater rebate.

The user interface module 250, in operation 720, causes a user interface to be presented with the promotional proposal. For example, a user interface may be displayed via the web interface 170 of the client device 160A, both of FIG. 1. The user interface may include the promotional proposal, information about the tenants, information about the application, or any suitable combination thereof.

In operation 730, the promotion module 260 receives, via the user interface, a modification to the promotional proposal. The modification may change the tenants to which the promotion is to be offered (e.g., from all tenants to high priority tenants only), change the rate increase to be offered (e.g., by increasing the offer from 92% to 100%), change the price to be asked (e.g., by increasing the price from 40% of the normal usage fee to 50%), or any suitable combination thereof.

The promotion module 260, in operation 740, generates, based on the modification, a modified promotion. In operation 750, the promotion module 260 sends information regarding the modified promotion to a tenant. For example, an email may be sent to an administrator of each tenant that the promotion is being offered to (e.g., all tenants, all high priority tenants, or a specified list of tenants selected in the user interface). Tenants that accept the promotion may be charged in accordance with the promotion and provided services in accordance with the promotion.

The loading for the application, used in operation 710 of the method 700 and in operation 610 of the method 600, may be determined based on historical usage data. The historical usage data may indicate, for a sequence of periods of time, computing resources allocated to the application, a number of requests serviced by the application, a percentage of allocated resources consumed by the application, a timeliness of responses provided by the application, or any suitable combination thereof. The historical usage data may indicate trends (e.g., increasing or decreasing usage over time), cycles (e.g., times of day, days of week, or months of year with higher or lower usage than average), or both.

A machine learning model may be trained on the historical usage data to predict loading for the application. Thus, the method 700 may be modified to include training a machine learning model using time-series resource consumption data. For example, when eight weeks of historical usage data are available, the first four weeks of data may be used as an input and the fifth week (or twenty-ninth day) be used as a training output. The time window for input and output may be shifted one day or one week at a time, allowing for a large number of training examples to be drawn from the historical usage data. After training, the machine learning model is able to take historical usage data as an input and generate predicted loading for the application as an output.

The time-series resource consumption data used for training the machine learning model and as input to the trained machine learning model to predict a loading for the application may include, for a series of points in time, hardware resource consumption by the application, a number of requests for the application by at least a subset of the plurality of tenants, a duration of time for processing each request, a cost to provide resources consumed by the application, a price paid by at least a subset of the plurality of tenants for access to the application, an amount of time to allocate additional resources to the application, or any suitable combination thereof.

As discussed above, the predicted loading for the application may be used in the method 600 to set rate limits for tenants. Alternatively or additionally, the predicted loading for the application may be used in the method 700 to generate promotions. As still another alternative, the predicted loading for the application may be used to control resource allocation. For example, if the historical usage data indicates that the application will likely be unable to service requests at the minimum guaranteed rate to one or more tenants for a period of time, additional computing resources may be allocated to the application for the period of time to improve a quality of service.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: a memory that stores instructions; and one or more processors coupled to the memory and configured to execute the instructions to perform operations comprising: determining, for each tenant of a plurality of tenants, based on a priority for the tenant and a loading for an application, a rate limit for use of the application by the tenant; and processing requests for the application by the plurality of tenants in accordance with the determined rate limits for the plurality of tenants.

In Example 2, the subject matter of Example 1, wherein the operations further comprise: determining the loading for the application based on historical usage data.

In Example 3, the subject matter of any one or more of Examples 1-2, wherein the operations further comprise: based on historical usage data, allocating resources for the application.

In Example 4, the subject matter of any one or more of Examples 1-3, wherein the operations further comprise: based on a determination that the loading for the application will be below a predetermined threshold during a future period of time, offering, to a first tenant, a discount for usage of the application during the future period of time.

In Example 5, the subject matter of any one or more of Examples 1-4, wherein the operations further comprise: based on a determination that the loading for the application will be above a predetermined threshold during a future period of time, offering, to a first tenant, a rebate for reduced usage of the application during the future period of time.

In Example 6, the subject matter of any one or more of Examples 1-5, wherein the operations further comprise: based on the loading for the application, generating a promotional proposal for usage of the application; causing a user interface to be presented with the promotional proposal; receiving, via the user interface, a modification to the promotional proposal; generating, based on the modification, a modified promotion; and sending information regarding the modified promotion to at least a subset of the plurality of tenants.

In Example 7, the subject matter of any one or more of Examples 1-6, wherein the operations further comprise: determining the loading for the application based on expected usage data provided by at least a subset of the plurality of tenants.

In Example 8, the subject matter of any one or more of Examples 1-7, wherein the operations further comprise: determining the loading for the application using a trained machine learning model.

In Example 9, the subject matter of Example 8, wherein the operations further comprise: training the machine learning model using time-series resource consumption data.

In Example 10, the subject matter of Example 9, wherein the time-series resource consumption data comprises, for a series of points in time, hardware resource consumption by the application, a number of requests for the application by at least a subset of the plurality of tenants, and a duration of time for processing each request.

In Example 11, the subject matter of any one or more of Examples 9-10, wherein the time-series resource consumption data comprises, for a series of points in time, a cost to provide resources consumed by the application, a price paid by at least a subset of the plurality of tenants for access to the application, and an amount of time to allocate additional resources to the application.

Example 12 is a non-transitory computer-readable medium that stores instructions that, when executed by one or more processors, cause the one or more processors to perform operations comprising: determining, for each tenant of a plurality of tenants, based on a priority for the tenant and a loading for an application, a rate limit for use of the application by the tenant; and processing requests for the application by the plurality of tenants in accordance with the determined rate limits for the plurality of tenants.

In Example 13, the subject matter of Example 12, wherein the operations further comprise: determining the loading for the application based on historical usage data.

In Example 14, the subject matter of any one or more of Examples 12-13, wherein the operations further comprise: based on historical usage data, allocating resources for the application.

In Example 15, the subject matter of any one or more of Examples 12-14, wherein the operations further comprise: based on a determination that the loading for the application will be below a predetermined threshold during a future period of time, offering, to a first tenant, a discount for usage of the application during the future period of time.

In Example 16, the subject matter of any one or more of Examples 12-15, wherein the operations further comprise: based on a determination that the loading for the application will be above a predetermined threshold during a future period of time, offering, to a first tenant, a rebate for reduced usage of the application during the future period of time.

In Example 17, the subject matter of any one or more of Examples 12-16, wherein the operations further comprise: based on the loading for the application, generating a promotional proposal for usage of the application; causing a user interface to be presented with the promotional proposal; receiving, via the user interface, a modification to the promotional proposal; generating, based on the modification, a modified promotion; and sending information regarding the modified promotion to at least a subset of the plurality of tenants.

Example 18 is a method comprising: determining, by one or more processors and for each tenant of a plurality of tenants, based on a priority for the tenant and a loading for an application, a rate limit for use of the application by the tenant; and processing requests for the application by the plurality of tenants in accordance with the determined rate limits for the plurality of tenants.

In Example 19, the subject matter of Example 18 includes determining the loading for the application based on historical usage data.

In Example 20, the subject matter of any one or more of Examples 18-19 includes, based on historical usage data, allocating resources for the application.

Example 21 is an apparatus comprising means to implement any of Examples 1-20.

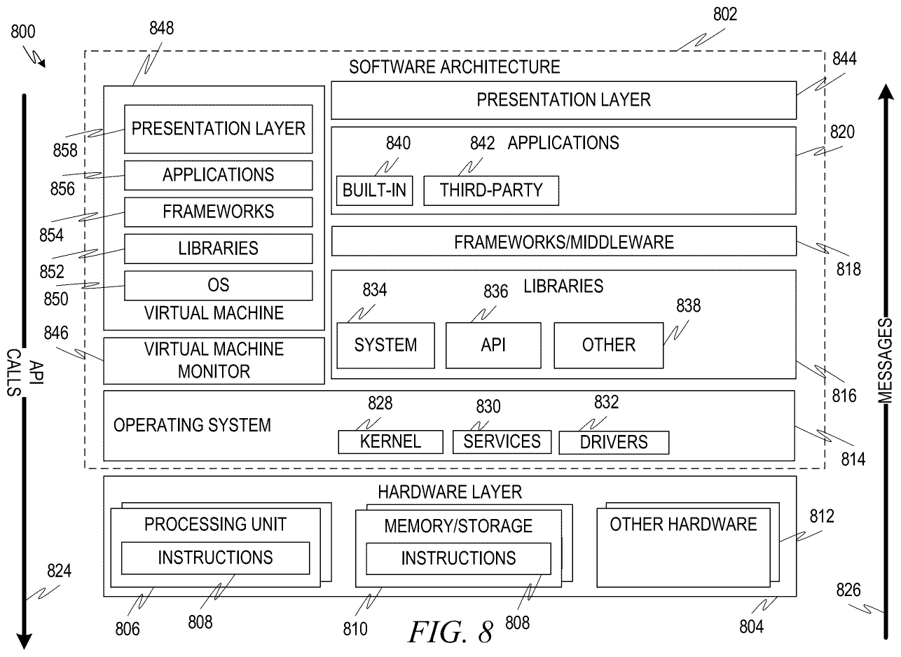

FIG. 8 shows a block diagram 800 showing one example of a software architecture 802 for a computing device. The software architecture 802 may be used in conjunction with various hardware architectures, for example, as described herein. FIG. 8 is merely a non-limiting example of a software architecture, and many other architectures may be implemented to facilitate the functionality described herein. A representative hardware layer 804 is illustrated and can represent, for example, any of the above referenced computing devices. In some examples, the hardware layer 804 may be implemented according to the architecture of the computer system of FIG. 9.

The representative hardware layer 804 comprises one or more processing units 806 having associated executable instructions 808. Executable instructions 808 represent the executable instructions of the software architecture 802, including implementation of the methods, modules, subsystems, and components, and so forth described herein and may also include memory and/or storage modules 810, which also have executable instructions 808. Hardware layer 804 may also comprise other hardware as indicated by other hardware 812 which represents any other hardware of the hardware layer 804, such as the other hardware illustrated as part of the software architecture 802.

In the example architecture of FIG. 8, the software architecture 802 may be conceptualized as a stack of layers where each layer provides particular functionality. For example, the software architecture 802 may include layers such as an operating system 814, libraries 816, frameworks/middleware 818, applications 820, and presentation layer 844. Operationally, the applications 820 and/or other components within the layers may invoke API calls 824 through the software stack and access a response, returned values, and so forth illustrated as messages 826 in response to the API calls 824. The layers illustrated are representative in nature and not all software architectures have all layers. For example, some mobile or special purpose operating systems may not provide a frameworks/middleware 818 layer, while others may provide such a layer. Other software architectures may include additional or different layers.

The operating system 814 may manage hardware resources and provide common services. The operating system 814 may include, for example, a kernel 828, services 830, and drivers 832. The kernel 828 may act as an abstraction layer between the hardware and the other software layers. For example, the kernel 828 may be responsible for memory management, processor management (e.g., scheduling), component management, networking, security settings, and so on. The services 830 may provide other common services for the other software layers. In some examples, the services 830 include an interrupt service. The interrupt service may detect the receipt of an interrupt and, in response, cause the software architecture 802 to pause its current processing and execute an interrupt service routine (ISR) when an interrupt is accessed.

The drivers 832 may be responsible for controlling or interfacing with the underlying hardware. For instance, the drivers 832 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 816 may provide a common infrastructure that may be utilized by the applications 820 and/or other components and/or layers. The libraries 816 typically provide functionality that allows other software modules to perform tasks in an easier fashion than to interface directly with the underlying operating system 814 functionality (e.g., kernel 828, services 830 and/or drivers 832). The libraries 816 may include system libraries 834 (e.g., C standard library) that may provide functions such as memory allocation functions, string manipulation functions, mathematic functions, and the like. In addition, the libraries 816 may include API libraries 836 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 816 may also include a wide variety of other libraries 838 to provide many other APIs to the applications 820 and other software components/modules.

The frameworks/middleware 818 may provide a higher-level common infrastructure that may be utilized by the applications 820 and/or other software components/modules. For example, the frameworks/middleware 818 may provide various graphical user interface (GUI) functions, high-level resource management, high-level location services, and so forth. The frameworks/middleware 818 may provide a broad spectrum of other APIs that may be utilized by the applications 820 and/or other software components/modules, some of which may be specific to a particular operating system or platform.

The applications 820 include built-in applications 840 and/or third-party applications 842. Examples of representative built-in applications 840 may include, but are not limited to, a contacts application, a browser application, a book reader application, a location application, a media application, a messaging application, and/or a game application. Third-party applications 842 may include any of the built-in applications 840 as well as a broad assortment of other applications. In a specific example, the third-party application 842 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 842 may invoke the API calls 824 provided by the mobile operating system such as operating system 814 to facilitate functionality described herein.

The applications 820 may utilize built-in operating system functions (e.g., kernel 828, services 830 and/or drivers 832), libraries (e.g., system libraries 834, API libraries 836, and other libraries 838), and frameworks/middleware 818 to create UIs to interact with users of the system. Alternatively, or additionally, in some systems, interactions with a user may occur through a presentation layer, such as presentation layer 844. In these systems, the application/module “logic” can be separated from the aspects of the application/module that interact with a user.

Some software architectures utilize virtual machines. In the example of FIG. 8, this is illustrated by virtual machine 848. A virtual machine creates a software environment where applications/modules can execute as if they were executing on a hardware computing device. A virtual machine is hosted by a host operating system (operating system 814) and typically, although not always, has a virtual machine monitor 846, which manages the operation of the virtual machine 848 as well as the interface with the host operating system (i.e., operating system 814). A software architecture executes within the virtual machine 848 such as an operating system 850, libraries 852, frameworks/middleware 854, applications 856 and/or presentation layer 858. These layers of software architecture executing within the virtual machine 848 can be the same as corresponding layers previously described or may be different.

### Modules, Components and Logic

A computer system may include logic, components, modules, mechanisms, or any suitable combination thereof. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. One or more computer systems (e.g., a standalone, client, or server computer system) or one or more hardware processors may be configured by software (e.g., an application or application portion) as a hardware-implemented module that operates to perform certain operations as described herein.

A hardware-implemented module may be implemented mechanically or electronically. For example, a hardware-implemented module may comprise dedicated circuitry or logic that is permanently configured (e.g., as a special-purpose processor, such as a field programmable gate array [FPGA] or an application-specific integrated circuit [ASIC]) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Hardware-implemented modules may be temporarily configured (e.g., programmed), and each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). Multiple hardware-implemented modules are configured or instantiated at different times. Communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. The processor or processors may be located in a single location (e.g., within a home environment, an office environment, or a server farm), or the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

The systems and methods described herein may be implemented using digital electronic circuitry, computer hardware, firmware, software, a computer program product (e.g., a computer program tangibly embodied in an information carrier, e.g., in a machine-readable medium for execution by, or to control the operation of, data processing apparatus, e.g., a programmable processor, a computer, or multiple computers), or any suitable combination thereof.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites (e.g., cloud computing) and interconnected by a communication network. In cloud computing, the server-side functionality may be distributed across multiple computers connected by a network. Load balancers are used to distribute work between the multiple computers. Thus, a cloud computing environment performing a method is a system comprising the multiple processors of the multiple computers tasked with performing the operations of the method.

Operations may be performed by one or more programmable processors executing a computer program to perform functions by operating on input data and generating output. Method operations can also be performed by, and apparatus of systems may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. A programmable computing system may be deployed using hardware architecture, software architecture, or both. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out example hardware (e.g., machine) and software architectures that may be deployed.

### Example Machine Architecture and Machine-Readable Medium

FIG. 9 shows a block diagram of a machine in the example form of a computer system 900 within which instructions 924 may be executed for causing the machine to perform any one or more of the methodologies discussed herein. The machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU), or both), a main memory 904, and a static memory 906, which communicate with each other via a bus 908. The computer system 900 may further include a video display unit 910 (e.g., a liquid crystal display (LCD) or a cathode ray tube [CRT]). The computer system 900 also includes an alphanumeric input device 912 (e.g., a keyboard or a touch-sensitive display screen), a UI navigation (or cursor control) device 914 (e.g., a mouse), a storage unit 916, a signal generation device 918 (e.g., a speaker), and a network interface device 920.

### Machine-Readable Medium

The storage unit 916 includes a machine-readable medium 922 on which is stored one or more sets of data structures and instructions 924 (e.g., software) embodying or utilized by any one or more of the methodologies or functions described herein. The instructions 924 may also reside, completely or at least partially, within the main memory 904 and/or within the processor 902 during execution thereof by the computer system 900, with the main memory 904 and the processor 902 also constituting a machine-readable medium 922.

While the machine-readable medium 922 is shown in FIG. 9 to be a single medium, the term “machine-readable medium” may include a single medium or multiple media (e.g., a centralized or distributed database, and/or associated caches and servers) that store the one or more instructions 924 or data structures. The term “machine-readable medium” shall also be taken to include any tangible medium that is capable of storing, encoding, or carrying instructions 924 for execution by the machine and that cause the machine to perform any one or more of the methodologies of the present disclosure, or that is capable of storing, encoding, or carrying data structures utilized by or associated with the instructions 924. The term “machine-readable medium” shall accordingly be taken to include, but not be limited to, solid-state memories, and optical and magnetic media. Specific examples of machine-readable media include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

### Transmission Medium

The instructions 924 may further be transmitted or received over a communications network 926 using a transmission medium. The instructions 924 may be transmitted using the network interface device 920 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 924 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise.

What is claimed is:

1. A system comprising:
a memory that stores instructions; and
one or more processors coupled to the memory and configured to execute the instructions to perform operations comprising:
determining, for each tenant of a plurality of tenants, based on a priority for the tenant and a loading for an application, a rate limit for use of the application by the tenant; and
processing requests for the application by the plurality of tenants in accordance with the determined rate limits for the plurality of tenants.

2. The system of claim 1, wherein the operations further comprise:
determining the loading for the application based on historical usage data.

3. The system of claim 1, wherein the operations further comprise:
based on historical usage data, allocating resources for the application.

4. The system of claim 1, wherein the operations further comprise:
based on a determination that the loading for the application will be below a predetermined threshold during a future period of time, offering, to a first tenant, a discount for usage of the application during the future period of time.

5. The system of claim 1, wherein the operations further comprise:
based on a determination that the loading for the application will be above a predetermined threshold during a future period of time, offering, to a first tenant, a rebate for reduced usage of the application during the future period of time.

6. The system of claim 1, wherein the operations further comprise:
based on the loading for the application, generating a promotional proposal for usage of the application;
causing a user interface to be presented with the promotional proposal;
receiving, via the user interface, a modification to the promotional proposal;
generating, based on the modification, a modified promotion; and
sending information regarding the modified promotion to at least a subset of the plurality of tenants.

7. The system of claim 1, wherein the operations further comprise:
determining the loading for the application based on expected usage data provided by at least a subset of the plurality of tenants.

8. The system of claim 1, wherein the operations further comprise:
determining the loading for the application using a trained machine learning model.

9. The system of claim 8, wherein the operations further comprise:
training the machine learning model using time-series resource consumption data.

10. The system of claim 9, wherein the time-series resource consumption data comprises, for a series of points in time, hardware resource consumption by the application, a number of requests for the application by at least a subset of the plurality of tenants, and a duration of time for processing each request.

11. The system of claim 9, wherein the time-series resource consumption data comprises, for a series of points in time, a cost to provide resources consumed by the application, a price paid by at least a subset of the plurality of tenants for access to the application, and an amount of time to allocate additional resources to the application.

12. A non-transitory computer-readable medium that stores instructions that, when executed by one or more processors, cause the one or more processors to perform operations comprising:
determining, for each tenant of a plurality of tenants, based on a priority for the tenant and a loading for an application, a rate limit for use of the application by the tenant; and
processing requests for the application by the plurality of tenants in accordance with the determined rate limits for the plurality of tenants.

13. The non-transitory computer-readable medium of claim 12, wherein the operations further comprise:
determining the loading for the application based on historical usage data.

14. The non-transitory computer-readable medium of claim 12, wherein the operations further comprise:
based on historical usage data, allocating resources for the application.

15. The non-transitory computer-readable medium of claim 12, wherein the operations further comprise:
based on a determination that the loading for the application will be below a predetermined threshold during a future period of time, offering, to a first tenant, a discount for usage of the application during the future period of time.

16. The non-transitory computer-readable medium of claim 12, wherein the operations further comprise:
based on a determination that the loading for the application will be above a predetermined threshold during a future period of time, offering, to a first tenant, a rebate for reduced usage of the application during the future period of time.

17. The non-transitory computer-readable medium of claim 12, wherein the operations further comprise:
based on the loading for the application, generating a promotional proposal for usage of the application;
causing a user interface to be presented with the promotional proposal;
receiving, via the user interface, a modification to the promotional proposal;
generating, based on the modification, a modified promotion; and
sending information regarding the modified promotion to at least a subset of the plurality of tenants.

18. A method comprising:
determining, by one or more processors and for each tenant of a plurality of tenants, based on a priority for the tenant and a loading for an application, a rate limit for use of the application by the tenant; and
processing requests for the application by the plurality of tenants in accordance with the determined rate limits for the plurality of tenants.

19. The method of claim 18, further comprising:
determining the loading for the application based on historical usage data.

20. The method of claim 18, further comprising:
based on historical usage data, allocating resources for the application.
